(19) United States
(12) Patent Application Publication
(10) Pub. No.: US 2026/0077261 A1
(43) Pub. Date: Mar. 19, 2026

(54) A MOBILE PHONE PROTECTIVE COVER

(71) Applicant: Soolra LLC, Wilmington, DE (US)

(72) Inventors: Sagi YATOM, Tel Aviv (IL); Tal MELENBOIM, Tel Aviv (IL)

(73) Assignee: Soolra LLC, Wilmington, DE (US)

(21) Appl. No.: 19/329,796

(22) Filed: Sep. 16, 2025

Related U.S. Application Data
(60) Provisional application No. 63/696,739, filed on Sep. 19, 2024.

(51) Int. Cl. A63F 13/24; A45C 11/00; A63F 13/23; H04M 1/02

(52) U.S. Cl. CPC A63F 13/24; A45C 11/002; A63F 13/23; H04M 1/0203

(57) ABSTRACT

A mobile phone protective cover adapted to receive a mobile phone, comprises a protective upper cover having a first outer wall and a first inner wall; a protective lower cover having a second outer wall and a second inner wall; and a controller that comprises: a circuit board located between the second outer wall and the second inner wall; and input elements mounted to the protective lower cover, wherein each input element has a bottom portion and an upper portion, wherein the bottom portion of each input element is directed towards the second inner wall of the protective lower cover and is adapted to engage with the circuit board, and wherein the upper portion of each input element protrudes through the second outer wall of the protective lower cover, wherein each input element is adapted to provide at least one input to the circuit board.

### CROSS REFERENCE TO RELATED APPLICATIONS

This application claims the benefit of U.S. Provisional Application No. 63/696,739 filed on September 19, 2024, the contents of which are incorporated herein by reference.

### TECHNICAL FIELD

The present disclosure generally relates to game controllers for use with mobile phones.

### BACKGROUND

Retro-style games are a category of video games designed to invoke nostalgia by replicating the gameplay, controls, and visuals of classic games from the past. These games are often adapted for modern platforms, enabling players to revisit the entertainment experiences of their childhood. Originally, retro games were played using physical controllers or consoles to move characters and perform actions.

With the significant advancements in mobile phone capabilities, smartphones have become a dominant platform for gaming. Many users now enjoy playing a variety of games, including retro-style titles, on their mobile devices. These classic games are often executed via emulator software, which replicates old game consoles, allowing users to play through a smartphone’s touchscreen.

However, traditional retro games were controlled using directional pads or joysticks for movement, and action buttons for character commands. Playing these games through a touchscreen or virtual keyboard on a mobile device can diminish the authentic retro experience. While external game controllers offer a solution, they are often bulky and reduce the convenience that mobile gaming provides.

It would therefore be advantageous to provide a solution that overcomes the challenges noted above.

### SUMMARY OF THE DISCLOSURE

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a mobile phone protective cover adapted to receive a mobile phone. The mobile phone protective cover comprises: a protective upper cover having a first outer wall and a first inner wall, the first inner wall being opposite to the first outer wall; a protective lower cover having a second outer wall and a second inner wall, the second inner wall being opposite to the second outer wall; and a controller, wherein the controller comprises: a circuit board, the circuit board being located between the second outer wall and the second inner wall of the protective lower cover; and a set of input elements mounted to the protective lower cover, wherein each input element has a bottom portion and an upper portion, wherein the bottom portion of each input element is directed towards the second inner wall of the protective lower cover and is adapted to engage with the circuit board, and wherein the upper portion of each input element protrudes through the second outer wall of the protective lower cover, wherein each input element is adapted to provide at least one input to the circuit board.

Certain embodiments disclosed herein include mobile phone at least partially within a protective cover. The protective cover comprises: a protective upper cover having a first outer wall and a first inner wall, the first inner wall being opposite to the first outer wall; a protective lower cover having a second outer wall and a second inner wall, the second inner wall being opposite to the second outer wall; and a controller, wherein the controller comprises: a circuit board, the circuit board being located between the second outer wall and the second inner wall of the protective lower cover; and a set of input elements mounted to the protective lower cover, wherein each input element has a bottom portion and an upper portion, wherein the bottom portion of each input element is directed towards the second inner wall of the protective lower cover and is adapted to engage with the circuit board, and wherein the upper portion of each input element protrudes through the second outer wall of the protective lower cover, wherein each input element is adapted to provide at least one input to the circuit board..

### BRIEF DESCRIPTION OF THE DRAWING

In the drawing:

FIG. 1 shows a front view of a mobile phone protective cover with integrated game controller in a disassembled state, according to an embodiment.

FIG. 2 shows a back view of the mobile phone protective cover with integrated game controller in an assembled state, according to an embodiment.

FIG. 3 shows a front view of the mobile phone protective cover with integrated game controller in an assembled state, according to an embodiment;

FIG. 4 shows a back view of the mobile phone protective cover with integrated game controller in an assembled state, according to an embodiment.

FIG. 5 shows an exploded back view of the mobile phone protective cover with integrated game controller, according to an embodiment.

FIG. 6 shows a schematic diagram of a circuit board, according to an embodiment, and

FIG. 7 shows a front view of the mobile phone protective cover with integrated game controller that is partially mounted on a front end of a mobile phone, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A mobile phone protective cover with an integrated game controller is disclosed. The mobile phone protective cover includes a protective upper cover and a protective lower cover that are adapted for attachment and detachment from each other. The mobile phone protective cover further includes a circuit board. The circuit board is installed between the outer wall and the inner wall of the protective lower cover. The mobile phone protective cover further includes a set of input elements. Each input element has a first end and a second end, the first end of each input element is directed to the inner wall and adapted to engage with the circuit board, and the second end of each input element protrudes through the outer wall. Each input element is adapted to provide inputs to the circuit board, e.g., to control the operation of circuit board or a game or other program executing on the mobile phone. In addition, the mobile phone protective cover is adapted to transmit signals to a mobile phone, therefore allowing users to play mobile games using the mobile phone protective cover.

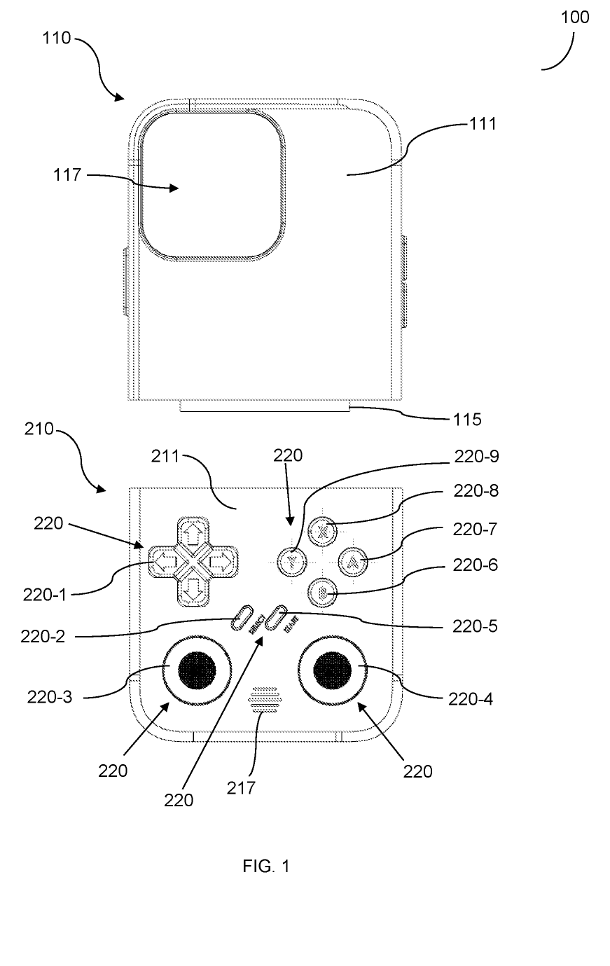

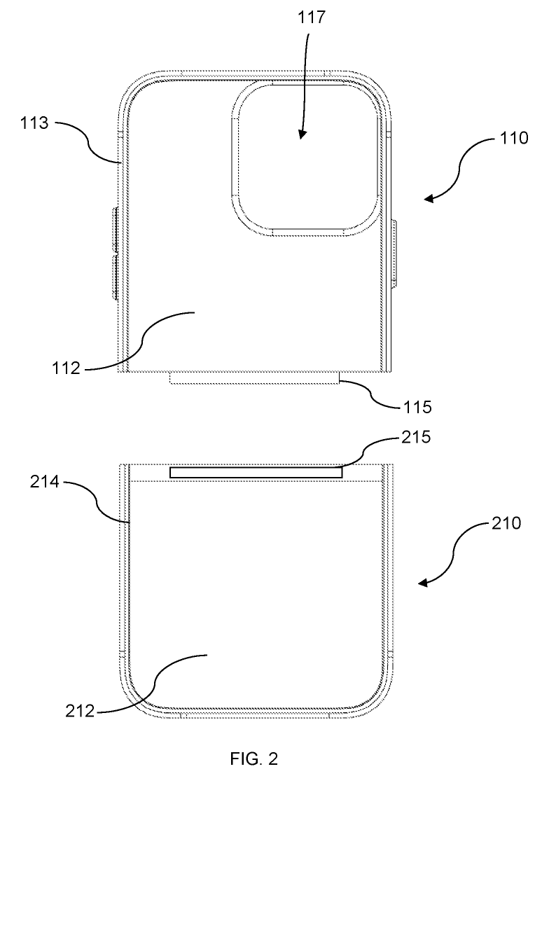

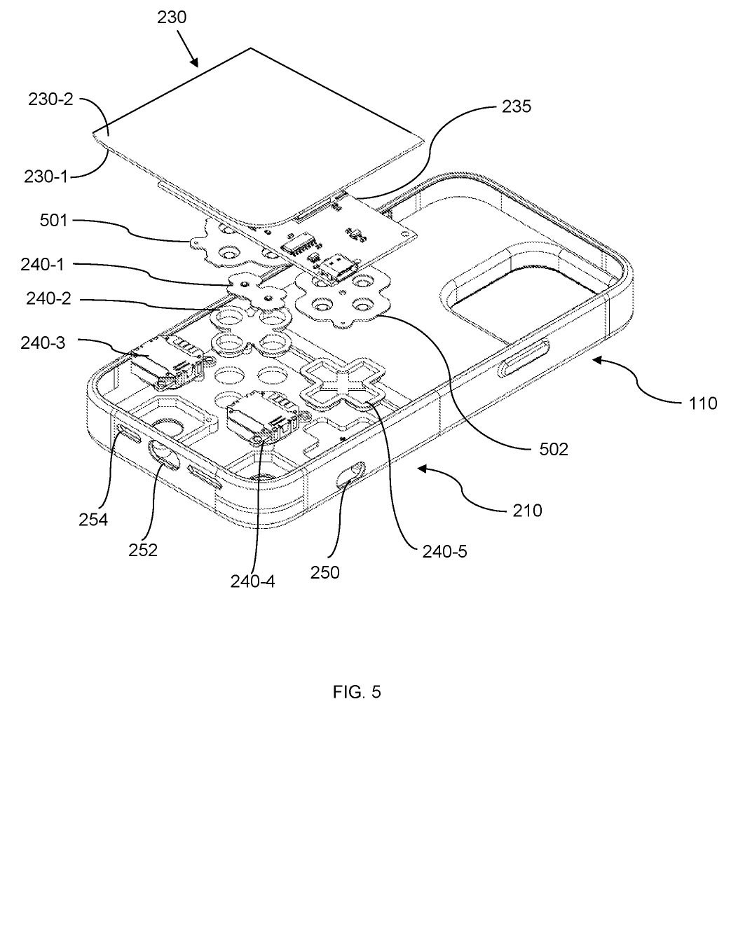

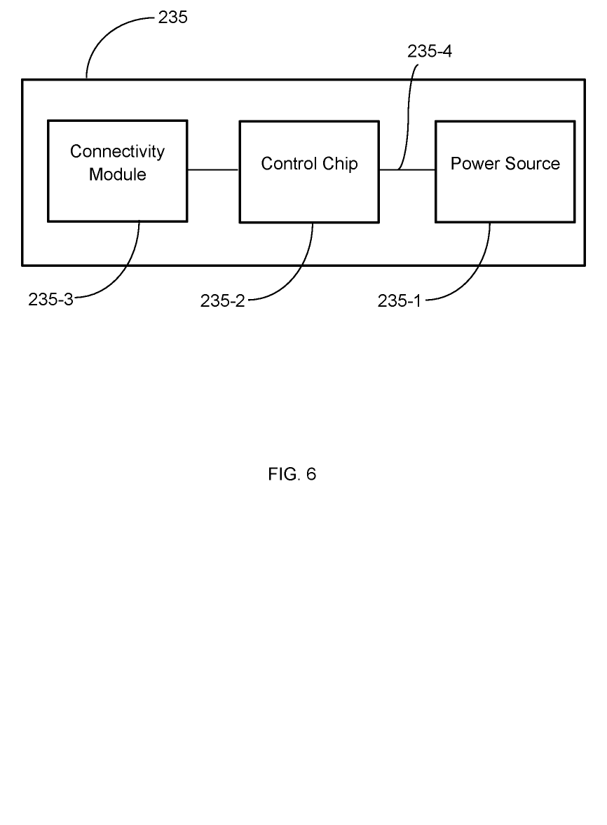

FIG. 1-2 show a front view of a disassembled mobile phone protective cover with integrated game controller, hereinafter the mobile phone protective cover (MPPC) 100, according to an embodiment. The MPPC 100 includes at least a protective upper cover 110, a protective lower cover 210, a circuit board 235 (shown in FIGS. 5 and 6), and a set of input elements 220.

The protective upper cover 110 has a first outer wall 111 and a first inner wall 112. The first inner wall 112 being opposite to the first outer wall 111. The protective upper cover 110 further includes a first set of side walls 113 that is partially surrounding the first inner wall 112. The protective upper cover 110 is designed to receive an upper back end of a mobile phone into the first inner wall 112, thereby providing protection to the back end of the mobile phone (not shown). The protective upper cover 110 may further include a camera opening, e.g., the camera opening 117.

The protective lower cover 210 has a second outer wall 211 and a second inner wall 212. The second inner wall 212 being opposite to the second outer wall 211. The protective lower cover 210 further includes a second set of side walls 214 that is partially surrounding the second inner wall 212. The protective lower cover 210 further includes a set of designated input element openings adapted to receive the input elements 220 and allow the input elements to contact the circuit board 235, as further discussed herein.

The protective lower cover 210 is designed to fulfill two objectives. The first objective is to provide protection to the lower back end of a mobile phone (not shown). To that end, the protective lower cover 210 is designed to receive the lower back end of the mobile phone between the side walls 214, such that the lower back end of the mobile phone is directed towards the inner wall 212. The second objective of the protective lower cover 210 is to be used as a game controller for mobile games and retro games that execute using the mobile phone.

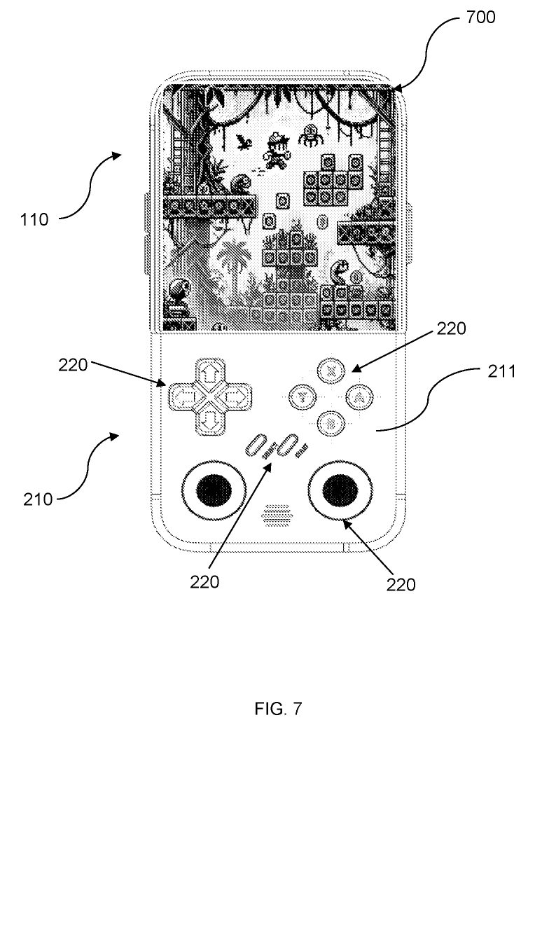

To that end, the protective lower cover 210 is designed to receive a lower front end of the mobile phone between the side walls 214, such that the lower front end of the mobile phone, i.e., the lower end of the mobile phone screen, is directed towards the inner wall 212, as shown in FIG. 7.

Reference is now made to FIG. 6. The circuit board 235 may include, among other components, a power provider 235-1, at least one control chip 235-2, at least one connectivity module 235-3. The power provider 235-1 may be, for example, a battery, an external power supply, and the like. The power provider 235-1 need not be a source of power itself but may convert or pass through power supplied to it via an input thereto for use by the other components on circuit board 235. In one embodiment, power supplied to the components of circuit board 235 via power provider 235-1 may come from the mobile phone, e.g., via its universal serial bus (USB) connector. The power provider 235-1 is configured to supply electric power to the circuit board 235 for use by the components thereon, thereby allowing the operation of the circuit board 235.

The control chip 235-2 is configured to receive signals from the input elements 220 and transmit operational signals to the mobile phone (not shown). The connectivity module may include for example, wired or wireless communication, such as but not limited to, Bluetooth, Near Field Communication (NFC), and the like. The control chip 235-2 is adapted to transmit signals through the connectivity module 235-3 to the mobile phone, thereby allowing to execute user selections and game moves initiated by the user of the mobile phone.

The input elements 220 may be connected or communicatively connected to the control chip 235-2. It should be noted that the various components of the circuit board 235 may be connected via a bus 235-4. In a further embodiment, the circuit board 235 is installed in between the second outer wall 211 and the second inner wall 212 of the protective lower cover 210. Note that although the use of input elements 220 is primarily described herein in terms of controlling retro games, in some embodiments the input elements 220 may be used to control other functions of the mobile phone when not being used for controlling games.

According to one embodiment, the circuit board 235 and its additional components, such as the power provider 235-1, the control chip 235-2, the connectivity module 235-3, and the like, are mounted to a back plate, e.g., the back plate 230 of FIG. 5. The back plate 230 has a first side 230-1 adapted to accept at least the circuit board 235 and its components, and a second side 230-2 which, when attached to the protective lower cover 210, forms the second inner wall 212 of the protective lower cover 210.

The set of input elements 220 may include for example, one or more buttons, one or more function keys, one or more direction control components, also known as directional pad or a D-pad, one or more joysticks, one or more trackballs, one or more touch sensitive areas, a combination thereof, and the like. It should be noted that the set of input elements 220 shown in at least FIG. 1 are provided solely for ease of understanding and should not be construed as limiting the number or nature of such elements. Various modifications in the input elements may be made without departing from the scope of the invention.

In an embodiment, each input element 220, of the set of input elements 220, is mounted to the protective lower cover 210. The circuit board 235, and more specifically the control chip 235-2, is adapted to receive signals from each input element 220. Thus, each input element 220 is adapted to provide inputs to the circuit board 235, e.g., to control the operation of circuit board 235 or a game or other program executing on the mobile phone.

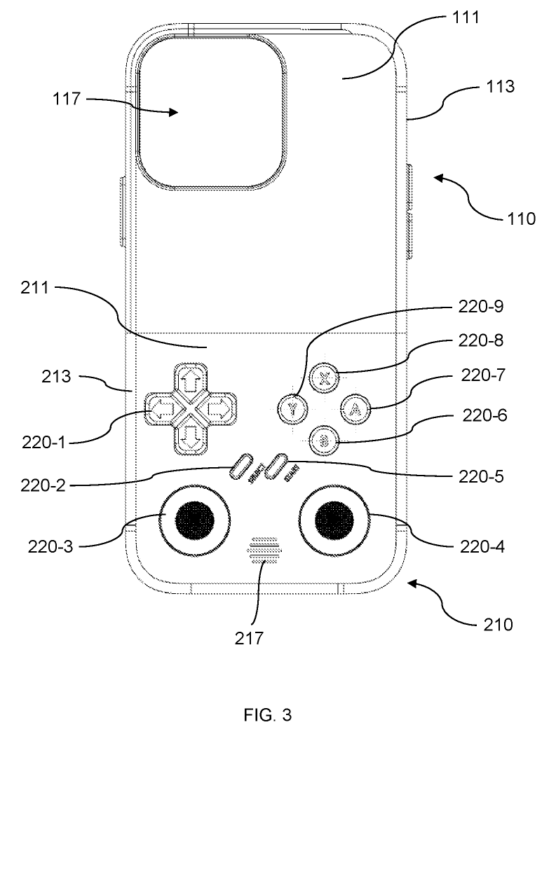

In an embodiment, each input element 220 has an upper portion 220-1 through 220-9 (shown in FIG. 1), which may each be a surface, and a bottom portion 240-1 through 240-5 (shown in FIG. 5), which may be a surface. The bottom portion 240-1 through 240-5 of each input element 220, is directed towards the second inner wall 212 and connected to the circuit board 235. The upper portion 220-1 through 220-9 of each input element 220 protrudes through the designated input element opening and over the second outer wall 211 of the protective lower cover 210, as shown in at least FIG. 1 and 3. Thus, the input elements 220 are visible and accessible for users to press, move, and operate the input elements 220.

Reference is now made to FIG. 5. According to an embodiment, at least one conductive silicone button, such as the conductive silicone button 501 and the conductive silicone button 502, is mounted to the circuit board 235. In addition, one or more input elements 220 are adapted to one or more conductive silicone buttons. An input element and a conductive silicone button may be connected via the bottom portion of the input element. For example, the conductive silicone button 501 is connected to the bottom portion 240-2 of the input elements 220-6 through 220-9, and the conductive silicone button 502 is connected to the bottom portion 240-5 of the input element 220-1 The conductive silicone button facilitates electrical contact when pressed by the input element 220.

Reference is now made to FIG. 2. In an embodiment, the protective lower cover and the protective upper cover have an interlocking mechanism that facilitates their attachment and detachment. According to one embodiment, the interlocking mechanism includes a male connector 115 which extends from the bottom edge of the protective upper cover 110, and a female connector 215 located at the top edge of the protective lower cover 210.

According to another embodiment, the interlocking mechanism includes a male connector which extends from the top edge of the protective lower cover 210, and a female connector located at the bottom edge of the protective upper cover 110. It should be noted that the interlocking mechanism may be implemented in many forms, such as, a male and female connectors integrated in the protective lower cover and in the protective upper cover, a magnetic male and female connectors, one or more fasteners, one or more straps, one or more buttons, and the like.

Reference is now made to FIG. 3. According to an embodiment, at least one heat dissipation opening, e.g., the heat dissipation opening 217, is formed in the protective lower cover. The heat dissipation opening 217 is used for preventing overheating of both the mobile phone and the circuit board components and maintain performances of both.

Reference is now made to FIG. 5. In an embodiment, the protective lower cover 210 may further include at least one power provider opening, e.g., the power provider opening 250, adapted in size and shape to an input to the power provider 235-1 to enable supplying power external thereto, at least one power port opening for charging the mobile phone, e.g., the power port opening 252, which is adapted in size and shape to the power port of the mobile phone, and at least one speaker opening, e.g., the speaker opening 254 which adapted in size and shape to the speakers of the mobile phone.

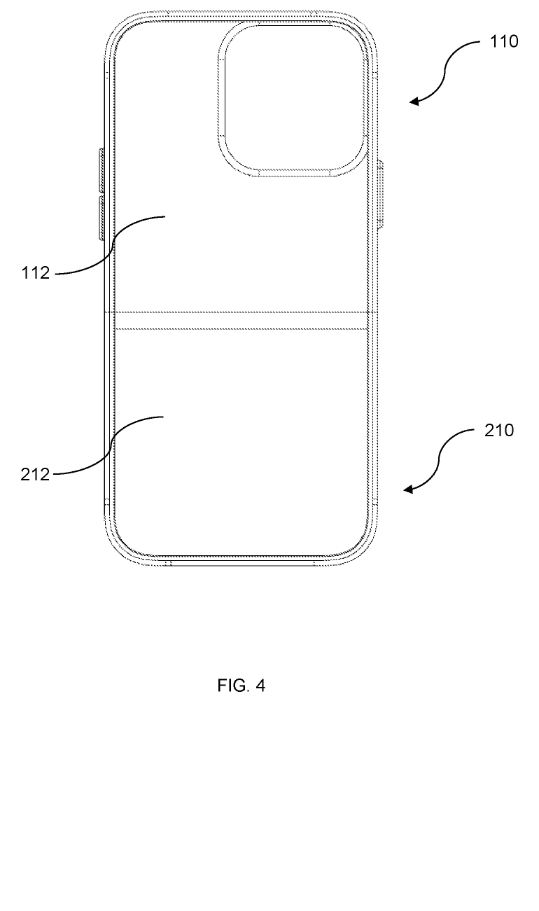

Reference is now made to FIG. 4 which shows the protective upper cover 110 and the protective lower cover 210 attached to each other, demonstrating their assembled state. In this assembled state, the first inner wall 112 and the second inner wall 212 together form a flat surface designed to receive the entire back end of the mobile phone (not shown). This state provides protection to the mobile phone against physical impacts and accidental drops. However, this is not an arrangement that can be used for gaming.

Reference is now made to FIG. 7. When a user is ready to start playing a game on their mobile phone, the protective upper cover 110 stays in its original position at the upper back end of the mobile phone 700, keeping the screen visible to the user. Meanwhile, the protective lower cover 210 is manually detached from the lower back end of the mobile phone and repositioned at the lower front end of the mobile phone so as to cover a portion thereof. This arrangement ensures that the upper front end of the mobile phone 700 remains visible to the user, while the second outer wall 211 of the protective lower cover 210 and the input elements 220, allowing the user to control the game, are positioned beneath the upper front end of the phone 700.

One advantage of employing the principles of the disclosure lies in the integration of a game controller within a mobile phone protective cover, offering a seamless solution to enhance the gaming experience on smartphones. By combining both protective and interactive functions into a single device, the disclosure addresses several challenges associated with mobile gaming. Traditional external game controllers often compromise the portability and convenience of mobile devices, while touchscreen controls may diminish the nostalgic and tactile experience of classic retro games. This approach eliminates the need for separate accessories, simplifying the gaming setup and making it more accessible for users.

The disclosed mobile phone protective cover also prioritizes user convenience and flexibility. The protective cover can be easily attached and detached from the mobile phone, allowing users to switch between protective and gaming modes without hassle. This modular approach ensures that users can maintain the protective benefits of the cover when not gaming, while still enjoying the full functionality of a dedicated game controller when needed.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

Unless otherwise explicitly specified herein, the drawings are not drawn to scale.

What is claimed is:

1. A mobile phone protective cover adapted to receive a mobile phone, comprising:
a protective upper cover having a first outer wall and a first inner wall, the first inner wall being opposite to the first outer wall;
a protective lower cover having a second outer wall and a second inner wall, the second inner wall being opposite to the second outer wall; and
a controller, wherein the controller comprises:
a circuit board, the circuit board being located between the second outer wall and the second inner wall of the protective lower cover; and
a set of input elements mounted to the protective lower cover, wherein each input element has a bottom portion and an upper portion, wherein the bottom portion of each input element is directed towards the second inner wall of the protective lower cover and is adapted to engage with the circuit board, and wherein the upper portion of each input element protrudes through the second outer wall of the protective lower cover, wherein each input element is adapted to provide at least one input to the circuit board.

2. The mobile phone protective cover of claim 1, wherein the controller is adapted to provide inputs to the mobile phone for controlling software running on the mobile phone.

3. The mobile phone protective cover of claim 1, wherein the controller is adapted to provide inputs to the mobile phone for controlling a game running on the mobile phone.

4. The mobile phone protective cover of claim 1, wherein the protective upper cover further comprises a first set of side walls that partially surrounds the first inner wall.

5. The mobile phone protective cover of claim 1, wherein the protective lower cover further comprises a second set of side walls that partially surrounds the second inner wall.

6. The mobile phone protective cover of claim 1, wherein the protective lower cover and the protective upper cover have an interlocking mechanism adapted to enable their attachment and detachment.

7. The mobile phone protective cover of claim 1, wherein the circuit board has at least one control chip and at least one connectivity module fixedly mounted thereon.

8. The mobile phone protective cover of claim 7, wherein the circuit board further has at least one power provider fixedly mounted thereon.

9. The mobile phone protective cover of claim 7, further comprises:
a back plate, wherein the back plate has a first end adapted to receive at least the circuit board with the control chip and the connectivity module mounted thereon, and a second end that forms the second inner wall of the protective lower cover.

10. The mobile phone protective cover of claim 9, wherein the circuit board further has at least one power provider fixedly mounted thereon.

11. The mobile phone protective cover of claim 7, wherein at least one control chip is adapted to receive signals from the input elements.

12. The mobile phone protective cover of claim 7, wherein at least one control chip is adapted to transmit signals to the mobile phone via the connectivity module.

13. The mobile phone protective cover of claim 1, wherein the set of input elements comprises at least one of: a button, a function key, a direction control component, an action control component, a joystick, a trackball, a touch sensitive area, and a combination thereof.

14. The mobile phone protective cover of claim 1, wherein at least one input element of the set of input elements comprises at least one conductive silicone button, wherein the at least one conductive silicone button is mounted to the circuit board, and wherein a bottom portion of the input element is adapted in at least one of size and shape to the conductive silicone button.

15. The mobile phone protective cover of claim 1, wherein there is at least one heat dissipation opening in the protective lower cover.

16. The mobile phone protective cover of claim 1, wherein there is at least one power provider opening adapted in size and shape to a power input of a power provider mounted on the circuit board.

17. A mobile phone at least partially within a protective cover, wherein the protective cover comprises:
a protective upper cover having a first outer wall and a first inner wall, the first inner wall being opposite to the first outer wall;
a protective lower cover having a second outer wall and a second inner wall, the second inner wall being opposite to the second outer wall; and
a controller, wherein the controller comprises:
a circuit board, the circuit board being located between the second outer wall and the second inner wall of the protective lower cover; and
a set of input elements mounted to the protective lower cover, wherein each input element has a bottom portion and an upper portion, wherein the bottom portion of each input element is directed towards the second inner wall of the protective lower cover and is adapted to engage with the circuit board, and wherein the upper portion of each input element protrudes through the second outer wall of the protective lower cover, wherein each input element is adapted to provide at least one input to the circuit board.
